(19) United States
(12) Patent Application Publication
(10) Pub. No.: US 2024/0275890 A1
(43) Pub. Date: Aug. 15, 2024

(54) PRINTING SYSTEM AND CONTROL METHOD THEREOF, INFORMATION PROCESSING APPARATUS AND IMAGE FORMING APPARATUS, AND NON-TRANSITORY COMPUTER-READABLE STORAGE MEDIUM

(71) Applicant: CANON KABUSHIKI KAISHA, Tokyo (JP)

(72) Inventor: HIROKI HACHIYA, Kanagawa (JP)

(21) Appl. No.: 18/435,038

(22) Filed: Feb. 7, 2024

(30) Foreign Application Priority Data
Feb. 15, 2023 (JP) 2023-021863

(51) Int. Cl. H04N 1/00; G06F 16/901

(52) U.S. Cl. CPC H04N 1/00039; G06F 16/901; H04N 1/00082

(57) ABSTRACT

An information processing apparatus that generates data to be processed by an image forming apparatus is provided. The information processing apparatus generates and stores analysis data and print data for each page, wherein the analysis data is generated before the print data, and wherein the generated analysis data is used for correction processing performed by the image forming apparatus; and generates index files, each of the generated index files including a storage destination of the generated analysis data or a storage destination of the generated print data, a category indicating whether data corresponding to the included storage destination is the analysis data or the print data, and link information to a next index file, wherein when the index file is generated, link information to the generated index file is described in an index file generated immediately before.

### BACKGROUND OF THE INVENTION

### Field of the Invention

The present invention relates to a printing system for performing cloud printing and a control method thereof, an information processing apparatus and an image forming apparatus, and a non-transitory computer-readable storage medium.

### Description of the Related Art

In conventional print processing, as a method of improving the image quality of a printed product, there is known a method of creating a low-resolution image based on input image data, obtaining an image correction value by analyzing the image, correcting the input image data, and performing printing (see, for example, Japanese Patent Laid-Open No. 2003-250057).

To print, by a printer, print document data such as a document created by document creation software needs to be converted into a format such as JPEG processible by a printer. In this case, an analysis image (low-resolution image) is first generated from print document data, and an image correction value (for example, gamut information) is obtained from the analysis image. Next, a print image (high-resolution image) is generated from the print document data, and the image correction value is applied to the print image to generate a final corrected image, thereby obtaining a state in which printing can be started. Hence, in print processing in which image correction processing is performed, the start of printing is delayed by the time for creating the analysis image, as compared to a case where image correction processing is not performed.

### SUMMARY OF THE INVENTION

In order to solve the above-described problem, according to one aspect of the present invention, there is provided a printing system including an information processing apparatus and an image forming apparatus, wherein the information processing apparatus comprises: at least one memory that stores at least one first program; and at least one first processor, the at least one first program causes the at least one first processor to: generate and store analysis data and print data for each page, wherein the analysis data is generated before the print data, and wherein the generated analysis data is used for correction processing performed by the image forming apparatus; and generate index files, each of the generated index files including a storage destination of the generated analysis data or a storage destination of the generated print data, a category indicating whether data corresponding to the included storage destination is the analysis data or the print data, and link information to a next index file, wherein when the index file is generated, link information to the generated index file is described in an index file generated immediately before, the image forming apparatus comprises: at least one memory that stores at least one second program; and at least one second processor, the at least one second program causes the at least one second processor to: acquire the index files from the information processing apparatus; and process the analysis data and the print data corresponding to the storage destinations included in the index files, in an order of the index files connected by the link information, in accordance with the category included in the index files.

According to another aspect, there is provided an information processing apparatus that generates data to be processed by an image forming apparatus, comprising: at least one memory that stores at least one program; and at least one processor, wherein the at least one program causes the at least one processor to: generate and store analysis data and print data for each page, wherein the analysis data is generated before the print data, and wherein the generated analysis data is used for correction processing performed by the image forming apparatus; and generate index files, each of the generated index files including a storage destination of the generated analysis data or a storage destination of the generated print data, a category indicating whether data corresponding to the included storage destination is the analysis data or the print data, and link information to a next index file, wherein when the index file is generated, link information to the generated index file is described in an index file generated immediately before.

According to still another aspect, there is provided an image forming apparatus that acquires data from an information processing apparatus and processes the acquired data, comprising: at least one memory that stores at least one program; and at least one processor, wherein the at least one program causes the at least one processor to: acquire index files from the information processing apparatus, each of the acquired index files including a storage destination of analysis data or a storage destination of print data generated by the information processing apparatus, a category indicating whether data corresponding to the included storage destination is the analysis data or the print data, and link information to a next index file; and process the analysis data and the print data corresponding to the storage destinations included in the index files, in an order of the index files connected by the link information, in accordance with the category included in the index file.

According to the present invention, generation of an analysis image and generation of a print image are performed in parallel, thereby transferring the analysis image that is generated relatively fast to a printer first and progressing processing of obtaining a correction value, and this can suppress delay of the start of printing.

Further features of the present invention will become apparent from the following description of exemplary embodiments with reference to the attached drawings.

### BRIEF DESCRIPTION OF THE DRAWINGS

FIG. 1 is a view showing the overall configuration of a cloud printing system;

FIG. 2 is a block diagram showing the hardware configuration of a client terminal;

FIG. 3 is a view showing the mechanism of index files;

FIGS. 4A and 4B illustrates a sequence chart showing a series of processes of the cloud printing system;

FIG. 5 is a flowchart of image data generation processing by a server; and

FIG. 6 is a flowchart of print processing by a printer.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### Cloud Printing System

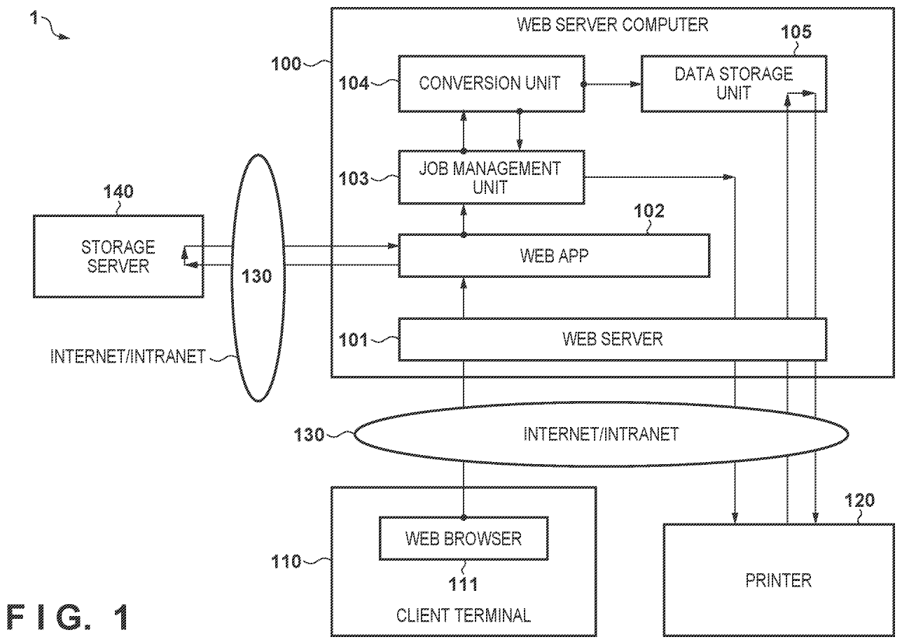

FIG. 1 is a view showing the overall configuration of a cloud printing system according to this embodiment. The cloud printing system 1 includes a server computer 100, and a client terminal 110, a printer 120, and a storage server 140, which are connected to the server computer 100 via a network 130.

The server computer 100 includes a WEB server 101, a WEB application 102, a job management unit 103, a conversion unit 104, and a data storage unit 105. Note that “application” is an abbreviation of an application program.

The client terminal 110 includes a WEB browser 111. The network 130 is the Internet or a local area network (LAN) and enables communication between servers, between a server and a client, or between a server and a printer.

The WEB application 102 is a program that provides a service to the client terminal 110 via the WEB browser 111. A user interface (UI) provided by the WEB application 102 is displayed on the WEB browser 111, and can accept a print request from a user. The elements of the print request are print settings and print document data. The print settings are, for example, an output size, an output sheet, a resolution, a double-sided setting, and the like. The print document data is data that needs to be converted into a format interpretable by the printer, and is, for example, a PDF file or a MicrosoftOffice® document (Excel, Word, or PowerPoint®).

The storage server 140 is a so-called cloud storage service, stores print document data of users, and is connected to the WEB application 102. The WEB application 102 accepts print document data in the storage server 140 and an input of print settings from the user, and transmits the print document data and the print settings as a print job to the job management unit 103. The job management unit 103 stores the print job received from the WEB application 102 and transmits it to the conversion unit 104.

The conversion unit 104 has a function of converting the print settings and the print document data received by the job management unit 103 into a format interpretable by the printer, and sending the converted data to the data storage unit 105. In conversion to a format interpretable by the printer, the print settings are converted into, for example, a file of xml format (called an index file in this specification), and the print document data is converted into an image of JPEG or the like. In the conversion of the print document data, an low-resolution “analysis image (or analysis data)” used for analysis to obtain an image correction value and a “print image (or print data)” that is an image to which the image correction value is applied are generated. The index file, the analysis image, and the print image are generated for each page of the print document data. The index file has the information of the URL of the analysis image or the URL of the print image.

The data storage unit 105 has a function of storing the data received from the conversion unit 104. The printer 120 polls the index file stored in the data storage unit 105, and acquires an image from the URL of the analysis image or the URL of the print image written in the index file. The data storage unit 105 also has a function of analyzing the acquired analysis image to obtain an image correction value, a function of applying the image correction value to the print image to generate a corrected image, and a function of printing the image.

### Hardware of Client Terminal

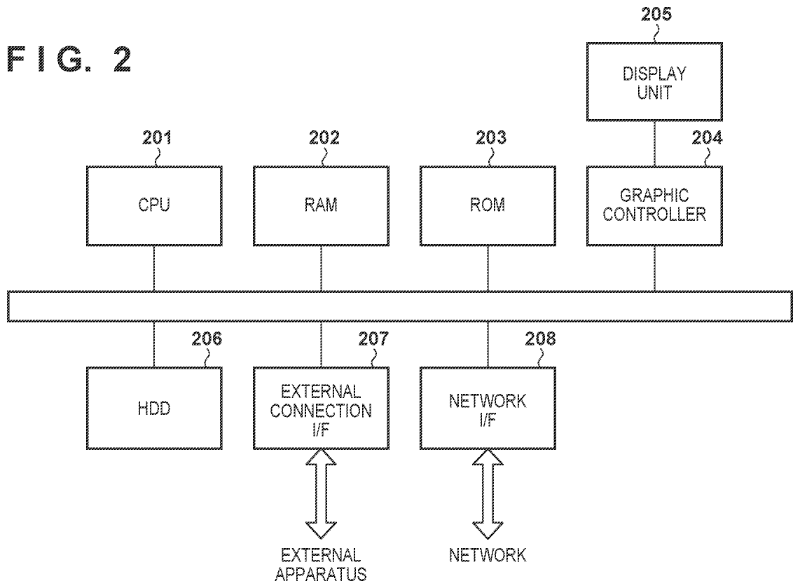

FIG. 2 is a block diagram showing the hardware configuration of the client terminal 110 according to this embodiment. The client terminal 110 includes a CPU (also called a processor) 201, a RAM 202, a ROM 203, a graphic controller 204, a display unit 205, and a hard disk drive (HDD) 206. Also, the client terminal 110 includes an external connection interface (“interface” will be referred to as “I/F” hereinafter) 207 and a network I/F 208, and the constituent parts are communicably connected via a bus 210.

The CPU 201 includes an arithmetic circuit, and performs overall control of the client terminal 110. The CPU 201 reads out a program stored in the ROM 203 or the HDD 206 to the RAM 202, and executes various kinds of processing. The ROM 203 stores a system program and the like used to control the client terminal 110. The graphic controller 204 generates a screen to be displayed on the display unit 205. The HDD 206 has a function as a storage area, and stores an application program and the like configured to execute various kinds of processing. Note that the HDD 206 is an example of a storage device, and the storage device can be formed by not an HDD but a Solid-State Drive (SSD) using a nonvolatile rewritable semiconductor memory.

The external connection interface (I/F) 207 is an interface used to connect various kinds of devices to the client terminal 110. For example, a display, a keyboard, a mouse, and the like can be connected via the external connection I/F 207. The network I/F 208 performs communication with the server computer 100 and the like via a network based on control of the CPU 201.

The hardware configuration of the client terminal 110 shown in FIG. 2 is the general configuration of an information processing apparatus. For this reason, the server computer 100 or the storage server 140 can also be implemented by an information processing apparatus having the hardware configuration shown in FIG. 2.

### Configuration of Index File

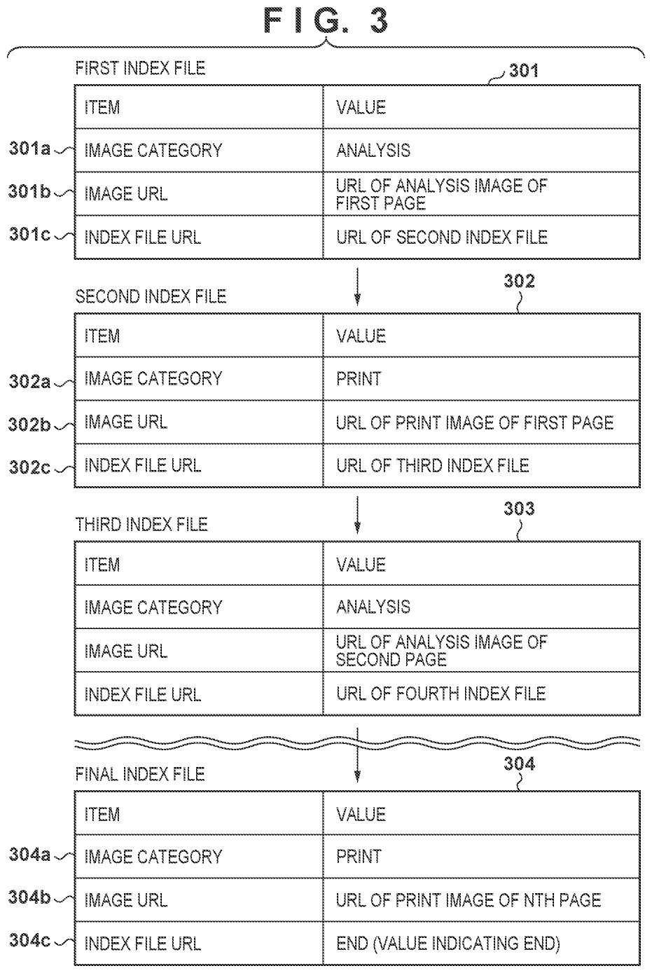

FIG. 3 showing the mechanism of connecting index files in a row. The index file has a role of causing the printer 120 to alternately acquire an analysis image and a print image created for each page by the conversion unit 104. In this mechanism, the URL of a next index file is described in an index file, and therefore, if the first index file is acquired, the index files and images of all pages can be acquired in a row.

An index file includes a plurality of pieces of information (for example, an output size, an output sheet, a resolution, a double-sided setting, and the like). In FIG. 3, an image category 301a, an image URL 301b, and an index file URL 301c are picked up from these pieces of information and shown. The image category 301a is a value used to discriminate whether the printer should perform analysis processing for generating an image correction value. The image URL 301b indicates the storage destination of data (image data). The index file URL 301c is an item used in the mechanism for connecting index files in a row, and is information indicating the next index file. The index file URL 301c is also called link information between index files. If the value of the image category 301a is “analysis”, the printer 120 performs analysis processing for image correction value generation. If the value is “printing”, the printer 120 does not perform analysis processing. The values “analysis” and “printing” can be predetermined values corresponding to these processes.

An index file information table 301 is information held by an index file generated by the conversion unit 104 first. The index file information table 301 holds the URL of the analysis image of the first page as the image URL 301b, and the URL of the second index file as the index file URL 301c. The URL of the second index file enables access to an index file information table 302 that is the second index file.

Next, the index file information table 302 holds the URL of the print image of the first page as an image URL 302b, and the URL of the third index file as an index file URL 302c. The URL of the third index file enables access to an index file information table 303.

An index file information table 304 is a final index file. A symbol (for example, a character string “END”) indicating that this is the final index file is written in an index file URL 304c, thereby notifying the printer 120 of the end of polling of the index file.

The basic mechanism for connecting index files in a row has been described above. One more mechanism exists in addition to this. The index file URL 301c is unknown until generation of the next index file is completed. Hence, for example, at the time when the index file information table 301 was generated, the URL of the second index file is not determined. For this reason, until the second index file is generated, a URL for referring to the index file itself is described as the index file URL 301c. At the timing when the conversion unit 104 has generated the next index file, the URL is rewritten from the self-reference URL to the URL of the next index file. Accordingly, the printer 120 continuously polls the first index file until the next index file is generated, and can access the next index file when it is generated. Note that in the following explanation, an index file will sometimes be denoted by reference numeral 301 irrespectively of the order.

### Sequence of Cloud Printing

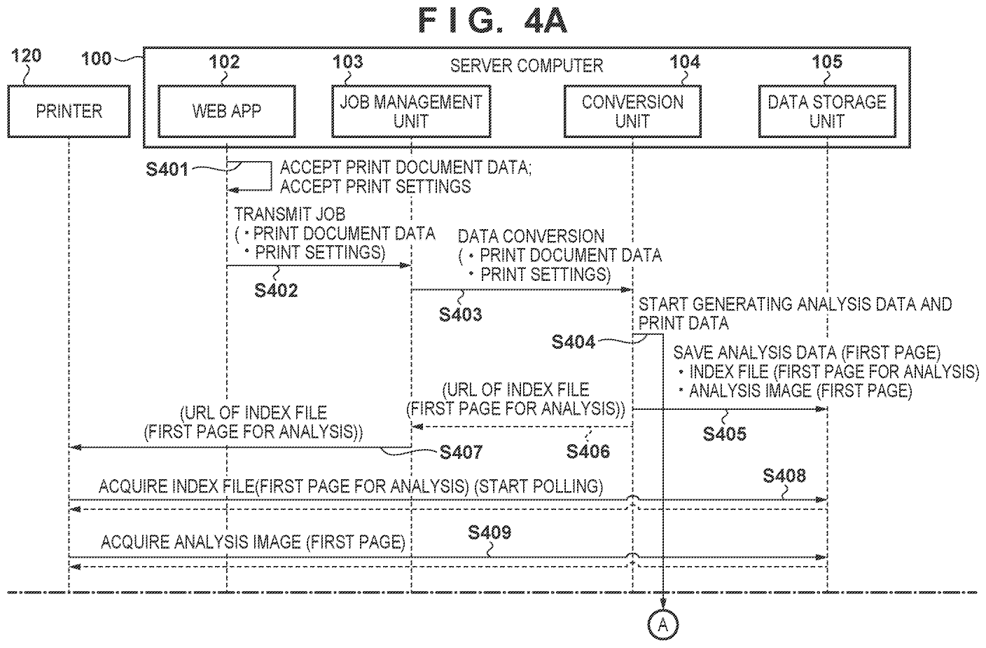

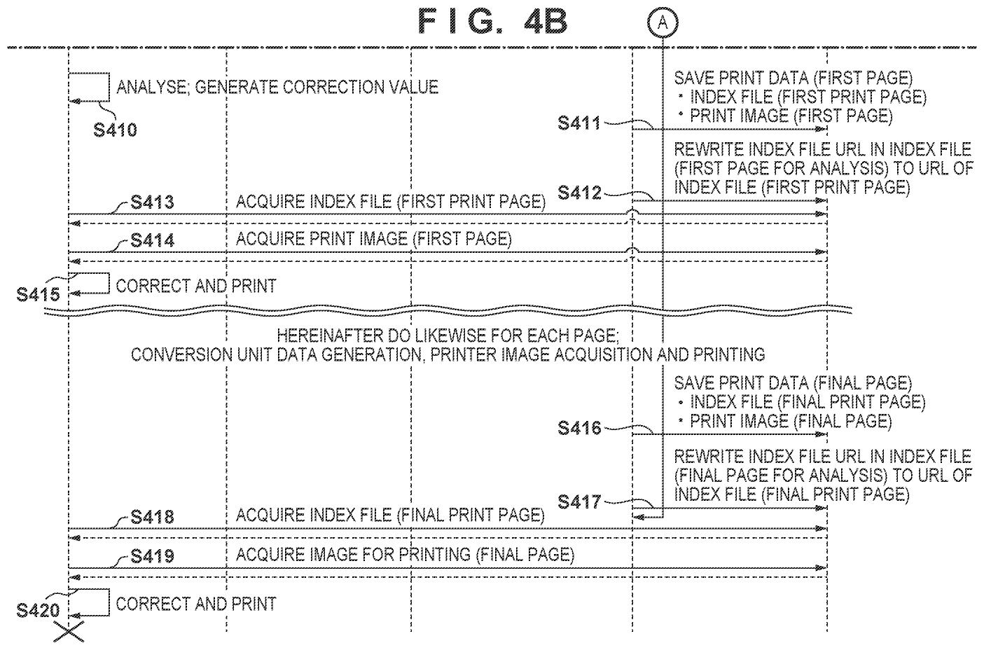

FIGS. 4A and 4B illustrates a sequence chart showing a series of processes of the cloud printing system. A symbol “S” in the description of each process means a step in the flowchart (the same will apply in this specification). A case where print document data includes a plurality of pages will be described as an example.

First, in S401, the WEB application 102 accepts a print request from the user. The print request includes print document data and print settings. In S402, the WEB application 102 transmits the print request in S401 as a print job to the job management unit.

In S403, the job management unit 103 transmits the print document data and the print settings to the conversion unit 104.

S404, S405, and S406 below operate in the conversion unit 104. In S404, the conversion unit 104 performs conversion processing of the print document data and the print settings received in S403. In the conversion processing, analysis data and print data are generated in parallel. More specifically, the analysis data includes an analysis image and an index file (for analysis), and the print data includes a print image and an index file (for printing).

The conversion unit 104 generates an analysis image (first page) from the print document data received in S403, and generates an index file (first page for analysis) from the print settings. At this generation time, a URL for referring the index file itself is described in the index file URL 301c of the index file (first page for analysis).

After that, in S405, the conversion unit 104 transmits the analysis data (first page) to the data storage unit 105 and stores it. The analysis image is processed with settings for a resolution lower than that of the print image and is therefore generated relatively faster than the print image. Hence, storage of the analysis data (first page) in S405 is performed before storage of the print data (first page) in S411.

If the processing of S405 is completed, in S406, the conversion unit 104 transmits the URL of an index file (first page for analysis) as a response to the job management unit 103. The URL of an index file is a URL indicating the index file.

In S407, the job management unit 103 transmits the URL of the index file (first page for analysis) received in S406 to the printer 120.

S408, S409, and S410 below operate in the printer 120. In S408, the printer 120 accesses the URL of the index file (first page for analysis) received in S407, and starts polling of the index file (first page for analysis). This polling is performed until the value of the index file URL 301c included in the acquired index file is monitored, and the value changes to a value different from the currently accessed URL. At the time of S408, the value of the index file URL 301c is the URL for referring to the index file itself. For this reason, as long as the value of the index file URL 301c included in the acquired index file equals the currently accessed URL, periodical access to the URL is repeated. That is, polling of the first index file (first page for analysis) is continued until the value of the index file URL 301c included in the acquired index file is updated.

In S409, the printer 120 accesses a URL indicated by the image URL 301b of the index file acquired in S408, thereby acquiring the analysis image of the first page. In S410, the printer 120 analyzes the acquired analysis image and generates an image correction value (correction parameter).

Successively to generation of analysis data, the conversion unit 104 generates print data, and in S411, transmits the generated print data (first page) to the data storage unit 105 and stores it. Step S411 is performed next to S410 for the sake of convenience. In fact, this step is performed in parallel to the procedure associated with the analysis image in S405 to S410. In S411, the print image (first page) and the index file (first page for printing) are stored.

Also, in S411, the URL of the second index file is decided. Hence, in S412, the conversion unit 104 rewrites the value of the index file URL 301c written in the index file (first page for analysis) stored in S405 from the URL for referring to the index file itself to the URL of the second index file.

In response to this, in S413, the printer 120 that is polling the index file accesses a URL indicated by the rewritten value of the index file URL 301c. Thus, the printer 120 acquires an index file (first page for printing) that is the second index file from the data storage unit 105.

Furthermore, in S414, the printer 120 refers to the value of the image URL 301b in the index file and accesses a URL indicated by the image URL 301b, thereby acquiring a print image (first page) from the data storage unit 105, like S409.

In S415, the printer 120 corrects the print image acquired in S414 by the image correction value obtained in S410, and starts printing in accordance with the print settings described in the index file (first page for printing). The processing of the first page has been described above.

In processing from the second page as well, the conversion unit 104 generates analysis data and print data and stores these in the data storage unit 105, and the printer 120 acquires these data and performs printing. This processing is repeated until the index file URL 301c obtains a value indicating the end. That is, the processing is repeated as many times as the number of pages of the print document data.

Finally, in S416, when generating a final index file (final page for printing), the conversion unit 104 describes a character string (for example, “END”) indicating that this is the final index file, like the index file URL 304c in FIG. 3.

Also, in S417, the conversion unit 104 rewrites the value of the index file URL 301c written in the index file (final page for analysis) from the URL for referring to the index file itself to the URL of the final index file (final page for printing).

S418, S419, and S420 below operate in the printer 120. In S418, the printer 120 reads the character string “END” described in S416 and ends the polling of the index file. Then, the printer 120 acquires a print image (final page) in S419, and performs correction and printing in S420, like S415, thereby completing the processing.

In this way, generation of an analysis image and generation of a print image are performed in parallel, thereby transferring the analysis image that is generated relatively fast to a printer first and progressing processing of obtaining an image correction value. This makes it possible to correct the print image immediately after generation of the image and start printing and thus suppress delay of the start of printing.

### Image Data Generation Processing in Server

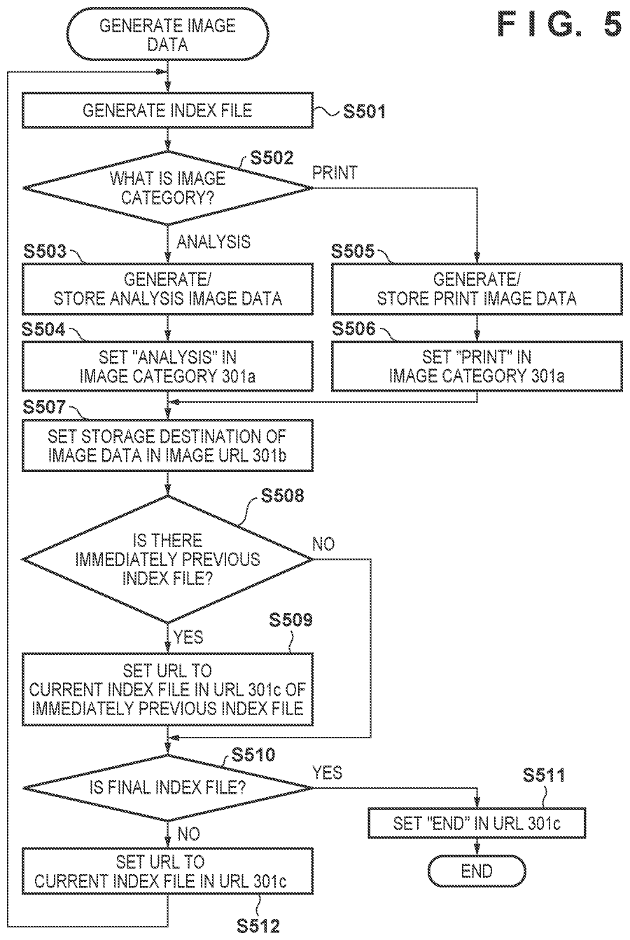

FIG. 5 shows a processing procedure by the server computer 100 in the sequence shown in FIGS. 4A and 4B.

When creation of image data from document data is started, the server computer 100 first generates an index file (step S501). Next, the category of image data to be created is determined (step S502). For example, if a setting for performing image correction by the printer is not included in the print job, analysis image data need not be generated. In this case, the image category is determined as “printing” in step S502. Also, for example, if a setting for performing image correction by the printer is included in the print job, analysis image data is generated. In this case, analysis image data and print image data are generated in parallel for each page. FIG. 5 shows that one of analysis data and print data is generated. However, these may be generated alternately in this way or may be generated in parallel. In step S502, data to be generated is decided, and the process branches to a corresponding side. When generating analysis image data, the image category is “analysis”. When generating print image data, the image category is “printing”.

If it is determined that the image category is “analysis”, analysis image data with a low pixel density is generated and stored in the data storage unit 105 (step S503). “Analysis” is set in the image category 301a of the index file (step S504).

If it is determined that the image category is “printing”, analysis image data with a high pixel density is generated and stored in the data storage unit 105 (step S505). “Printing” is set in the image category 301a of the index file (step S506).

Next, the URL of the storage destination at which the image data is stored in step S503 or S505 is set in the image URL 301b of the index file. It is determined whether there exists an index file for the same document data, which is generated immediately before the index file generated in step S501 (step S508). If a corresponding file exists, a URL to the current index file is set in the index file URL 301c of the index file (step S509).

It is determined whether the current index file is the final index file among the index files for the document data (step S510). If it is determined that the index file is the final index file, information “END” indicating the end is set in the index file URL 301c (step S511). On the other hand, if it is determined that the index file is not the final index file, a URL to the current index file is set in the index file URL 301c of the current index file (step S512).

By the above-described procedure, the image data generation procedure by the server computer 100 shown in FIGS. 4A and 4B is implemented.

### Print Processing in Printer (Image Forming Apparatus)

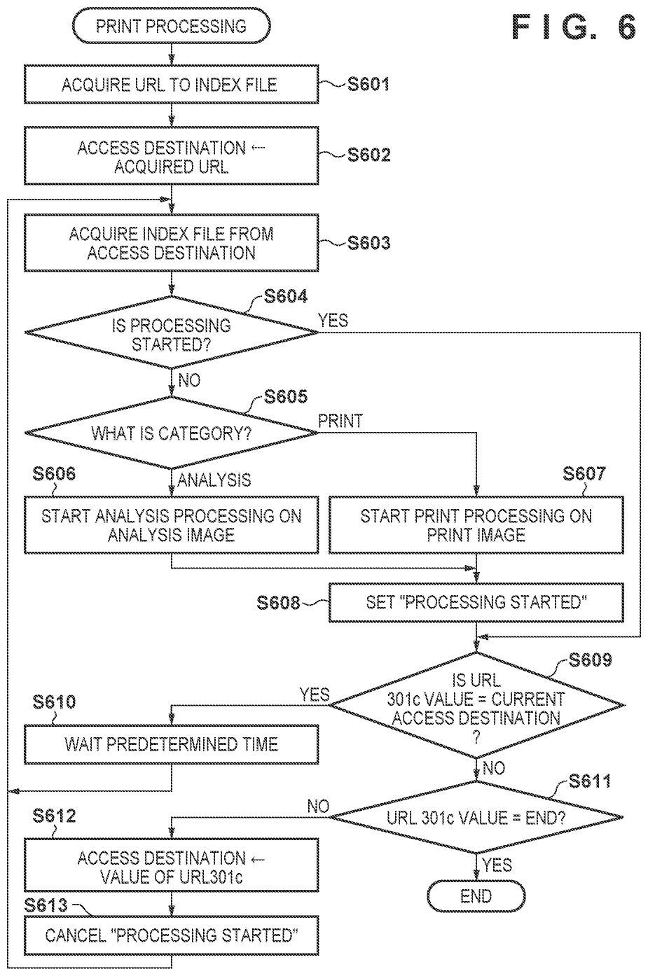

FIG. 6 shows a processing procedure by the printer 120 in the sequence shown in FIGS. 4A and 4B. The procedure shown in FIG. 6 indicates an operation of the printer 120 according to the creation of image data and an index file by the server computer 100 as shown in FIG. 5. Note that before this processing, information (to be referred to as a processing start flag here) indicating that processing of image data corresponding to an index file is started is set to a value indicating that the processing is not started. Alternatively, the latest index file may be obtained.

First, the URL of the index file of the first page is acquired (step S601). For example, the printer 120 may access the server computer 100 to acquire a list of print jobs, and a response to a request of a print job included in the list by the printer 120 may be acquired as the URL.

Next, the acquired URL is set as an access destination (step S602). A file is acquired from the access destination (step S603). Here, an index file is acquired. It is determined whether processing of image data (also called image data associated with the index file) indicated by the image URL 301b of the acquired index file is already started (step S604). If the processing is not already started, the image category 301a of the acquired index file is referred to determine whether the image data is for analysis or printing (step S605). If the image data is for analysis, analysis processing is started for the image data indicated by the image URL 301b of the acquired index file (step S606). If the image data is for printing, print processing is started (step S607). Analysis processing and print processing will be described later. When either processing is started, it may be executed in parallel to the processing shown in FIG. 5. After that, the processing start flag is set to “processing started” (step S608).

If it is determined in step S604 that the processing is not started, the process branches to step S609. In step S609, it is determined whether the value of the index file URL 301c of the acquired index file equals the current access destination, that is, the URL accessed in step S603. If the value equals the current access destination, the next index file is not generated yet, and therefore, the process waits for a predetermined time (step S610) and then branches to step S603.

On the other hand, it is determined in step S609 that the value of the index file URL 301c of the acquired index file does not equal the current access destination, it is determined whether the value of the index file URL 301c is END (step S611). That is, it is determined whether the value indicates the end of the data (or print job) to be processed. If it is determined that the value indicates the end, the processing of the index file is ended. At this time, print processing may still be continuing. However, the processing is not stopped, as a matter of course, and printing is completed when the processing is completed.

A case where it is determined in step S611 that the value of the index file URL 301c does not indicate END is a case where the index file URL 301c is updated by a URL to the next index file. The value of the index file URL 301c is set as the next access destination (step S612), and the processing start flag is canceled and set to a value indicating that the processing is not started (step S613). After that, the process branches to step S603.

The printer 120 thus operates to implement the sequence shown in FIGS. 4A and 4B. Analysis processing and print processing by the printer 120 will be described next.

### Analysis Processing in Printer (Image Forming Apparatus)

The printer 120 polls the server to acquire analysis data for each page and performs processing to be described below as an example. First, at least one of pieces of color information listed below is obtained from the analysis data. Note that in this example, the format of the analysis data is JPEG, and the color system is the YCbCr color system. Here, Y represents luminance, and Cb and Cr represent color differences of blue and red, respectively.
histogram of luminance
histogram of color difference
histogram of color difference on luminance basis
histogram of chroma
histogram of chroma on luminance basis
histogram of hue
histogram of hue on luminance basis

Next, a highlight point and a shadow point in the color space of the analysis data are calculated. In the obtained luminance histogram, a frequency is counted from the highest luminance, and a luminance value at which the count value reaches a threshold obtained by multiplying a total cumulative frequency by a predetermined ratio is obtained as a highlight point HLy. Also, in the luminance histogram, a frequency is counted from the lowest luminance, and a luminance value at which the count value reaches a threshold obtained by multiplying a total cumulative frequency by a predetermined ratio is obtained as a shadow point SDy. Note that luminance values before and after a luminance value at which the count value of the frequency reaches the threshold may be defined as the highlight point HLy and the shadow point SDy.

Furthermore, average color differences Cb and Cr at the highlight point HLy are calculated from the histogram of color difference and defined as color differences HLcb and HLcr at the highlight point HLy. Similarly, average color differences Cb and Cr at the shadow point SDy are calculated from the histogram of color difference and defined as color differences SDcb and SDcr at the shadow point SDy.

Next, an average chroma or an average hue is calculated, and the variance or standard deviation of luminances, color differences, chromas, or hues forming the color solid of the analysis data is calculated.

### Determination of Necessity of Image Correction

If the color solid is formed from the analysis data in the above-described way, the necessity of correction processing is determined for each type of correction. If it is determined to perform correction, a correction parameter is decided from the analysis data.

### (1) Expansion/Contraction in Luminance Direction

Expansion/contraction processing in the luminance direction is processing of expanding the original color solid in the luminance axis direction or contracting the color solid in the luminance axis direction. For example, if the total frequency of the histogram of luminance, the frequency of the highlight point HLy or shadow point SDy, or the luminance difference between the highlight point HLy and the shadow point SDy is smaller than a threshold, it is determined not to perform expansion/contraction processing in the luminance direction.

### (2) Color Cast Correction

Color cast correction is processing of aligning the axis of the original color solid with the luminance axis. For example, if the total frequency of the histogram of luminance, the frequency of the highlight point HLy or shadow point SDy, or the luminance difference between the highlight point HLy and the shadow point SDy is smaller than a threshold, it is determined not to perform color cast correction.

### (3) Expansion/Contraction in Chroma Direction

Expansion/contraction processing in the chroma direction is processing of expanding or contracting the original color solid on the Cb-Cr plane. For example, if the average chroma exceeds a threshold, or the average hue falls within a certain range, it is determined not to perform expansion/contraction processing in the chroma direction.

### (4) Noise Removal

Noise removal is processing of smoothing pixel values. A filter is used for noise removal. For example, a 3×3 weight coefficient matrix is used as the filter. In noise removal, for example, the weight coefficient matrix is superposed on an image, the center is defined as a pixel of interest, and a weighted average obtained by weighting the values of 3×3 pixels with respect to the pixel of interest as the center by corresponding weight coefficients is defined as the value of the pixel of interest. For example, if a variance value or standard deviation obtained from the analysis data exceeds a threshold, it is determined not to perform noise removal.

### (5) Tone Correction

Tone correction is processing of correcting an input value to an output value using a correction curve. For example, if the total frequency of the histogram of luminance, the frequency of the highlight point HLy or shadow point SDy, or the luminance difference between the highlight point HLy and the shadow point SDy is smaller than a threshold, it is determined not to perform tone correction.

### Creation of Correction Parameter

For correction decided to be performed in the above-described way, a correction parameter is decided in the following way.

### (1) Expansion/Contraction in Luminance Direction

When performing expansion/contraction in the luminance direction, an expansion/contraction parameter in the luminance direction is calculated based on the color solid of the analysis data. To do this, a highlight point HLy′ and a shadow point SDy′ at the moving destinations of the highlight point HLy and the shadow point SDy of the color solid of the analysis data are decided. Based on these as a reference, a parameter for converting a luminance component is decided for each color component.

### (2) Color Cast Correction

A 3×3 matrix for moving the unit vector of a vector HLy-SDy of the color solid of the analysis data to the unit vector of a vector HLy′-SDy′ of the color solid after correction is calculated as a parameter.

### (3) Expansion/Contraction in Chroma Direction

A chroma up rate is calculated (set) as a parameter based on the color solid of the analysis data. The chroma up rate may be a fixed value or may be set in accordance with color information such as an average chroma or an average hue or an image characteristic such as the type of an object. The chroma up rate may be smaller than 1.

### (4) Noise Removal

A noise filter is decided as a parameter based on the color solid of the analysis data. The noise filter may be selected from a plurality of types, and the weight coefficient or filter size may be changed appropriately in accordance with color information such as a variance value or a standard deviation or an image characteristic such as the type of an object.

### (5) Tone Correction

A tone correction curve is calculated (set) as a parameter based on the values of the highlight point HLy and the shadow point SDy of the color solid of the analysis data and the distribution of histogram. Print data is corrected using the set tone correction curve.

As in the above-described example, it is determined whether to perform various kinds of correction using analysis data, and to do so, a parameter is decided. The processing described above is executed when analysis image data is received.

### Image Correction

The printer 120 that has received print image data corrects the print image data using the correction parameter created based the analysis image data and prints the print image data. Correction is performed, for example, in the following way.

### (1) Expansion/Contraction in Luminance Direction

When performing expansion/contraction in the luminance direction, using the created expansion/contraction parameter in the luminance direction, the Y component of each pixel is converted such that HLy changes to HLy′, and SDy changes to SDy′ for the print image data.

### (2) Color Cast Correction

Using the 3×3 matrix that is a correction parameter, each color component of the print image data is converted.

### (3) Expansion/Contraction in Chroma Direction

Using the decided chroma up rate as a correction parameter, the color of the print data is converted such that it is enlarged or reduced on the Cr-Cb plane.

### (4) Noise Removal

Using the noise filter that is a decided correction parameter, filtering is performed for the print data to remove noise.

### (5) Tone Correction

The print data is corrected using the tone correction curve that is a decided correction parameter. After these correction processes, printing is executed. In this way, the image forming apparatus receives analysis data before print data for each page, judges the presence/absence of necessity of correction, and if necessary, decides a parameter for correction. Upon receiving print data of a corresponding page, the image forming apparatus executes correction using the decided parameter based on the decided result of determining the presence/absence of correction.

According to the present invention, a server that provides data to an image forming apparatus performs generation of analysis data and generation of print data in parallel, thereby transferring the analysis data that is generated relatively fast to the image forming apparatus first. The image forming apparatus can progress processing of obtaining an image correction parameter. This makes it possible to perform necessary correction immediately after generation of print data and suppress delay of the start of printing.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-021863, filed Feb. 15, 2023, which is hereby incorporated by reference herein in its entirety.

What is claimed is:

1. A printing system including an information processing apparatus and an image forming apparatus,
wherein the information processing apparatus comprises:
at least one memory that stores at least one first program; and
at least one first processor,
the at least one first program causes the at least one first processor to:
generate and store analysis data and print data for each page, wherein the analysis data is generated before the print data, and wherein the generated analysis data is used for correction processing performed by the image forming apparatus; and
generate index files, each of the generated index files including a storage destination of the generated analysis data or a storage destination of the generated print data, a category indicating whether data corresponding to the included storage destination is the analysis data or the print data, and link information to a next index file, wherein when the index file is generated, link information to the generated index file is described in an index file generated immediately before, the image forming apparatus comprises:
at least one memory that stores at least one second program; and
at least one second processor,
the at least one second program causes the at least one second processor to:
acquire the index files from the information processing apparatus; and
process the analysis data and the print data corresponding to the storage destinations included in the index files, in an order of the index files connected by the link information, in accordance with the category included in the index files.

2. The system according to claim 1, wherein the first processor generates the print data and the analysis data smaller than the print data in parallel.

3. The system according to claim 1, wherein the index file includes link information to the index file itself while no following index file is generated.

4. The system according to claim 1, wherein the generated index file corresponding to the print data of a final page includes information indicating an end as the link information.

5. The system according to claim 4, wherein after the image forming apparatus acquires the index file from the information processing apparatus, the image forming apparatus acquires a next index file indicated by the link information included in the index file.

6. The system according to claim 4, wherein if the link information of the index file acquired from the information processing apparatus indicates the end, the image forming apparatus ends a process for acquiring a next index file.

7. The system according to claim 1, wherein the image forming apparatus processes, as a target, data corresponding to the storage destination included in the acquired index file.

8. The system according to claim 7, wherein if the category of the acquired index file indicates analysis, the image forming apparatus determines necessity of correction based on the analysis data corresponding to the storage destination, and if necessary, generates a correction parameter.

9. The system according to claim 8, wherein if the category of the acquired index file indicates printing, and if there is the correction parameter, the image forming apparatus corrects the print data corresponding to the storage destination using the correction parameter and performs printing of the corrected printed data.

10. The system according to claim 8, wherein the image forming apparatus determines the necessity of the correction for each type of correction, and generates the correction parameter for each type of the correction.

11. An information processing apparatus that generates data to be processed by an image forming apparatus, comprising:
at least one memory that stores at least one program; and
at least one processor,
wherein the at least one program causes the at least one processor to:
generate and store analysis data and print data for each page, wherein the analysis data is generated before the print data, and wherein the generated analysis data is used for correction processing performed by the image forming apparatus; and
generate index files, each of the generated index files including a storage destination of the generated analysis data or a storage destination of the generated print data, a category indicating whether data corresponding to the included storage destination is the analysis data or the print data, and link information to a next index file, wherein when the index file is generated, link information to the generated index file is described in an index file generated immediately before.

12. An image forming apparatus that acquires data from an information processing apparatus and processes the acquired data, comprising:
at least one memory that stores at least one program; and
at least one processor,
wherein the at least one program causes the at least one processor to:
acquire index files from the information processing apparatus, each of the acquired index files including a storage destination of analysis data or a storage destination of print data generated by the information processing apparatus, a category indicating whether data corresponding to the included storage destination is the analysis data or the print data, and link information to a next index file; and
process the analysis data and the print data corresponding to the storage destinations included in the index files, in an order of the index files connected by the link information, in accordance with the category included in the index file.

13. A control method of a printing system including an information processing apparatus and an image forming apparatus, comprising:
by the information processing apparatus,
generating and storing analysis data and print data for each page wherein the analysis data is generated before the print data, and wherein the generated analysis data is used for correction processing performed by the image forming apparatus; and
generating index files, each of the generated index files including a storage destination of the generated analysis data or a storage destination of the generated print data, a category indicating whether data corresponding to the included storage destination is the analysis data or the print data, and link information to a next index file,
wherein, when the index file is generated, link information to the generated index file is described in an index file generated immediately before, and
by the image forming apparatus,
acquiring the index files from the information processing apparatus; and
processing the analysis data and the print data corresponding to the storage destination included in the index files, in an order of the index files connected by the link information, in accordance with the category included in the index file.

14. A non-transitory computer-readable storage medium storing a code executable by a computer, wherein the code executed by the computer causes the computer to execute:
generating and storing analysis data and print data for each page, wherein the analysis data is generated before the print data, and wherein the generated analysis data is used for correction processing performed by an image forming apparatus; and
generating index files, each of the generated index files including a storage destination of the generated analysis data or a storage destination of the generated print data, a category indicating whether data corresponding to the included storage destination is the analysis data or the print data, and link information to a next index file,
wherein, when the index file is generated, link information to the generated index file is described in an index file generated immediately before.

15. A non-transitory computer-readable storage medium storing a code executable by a processor of an image forming apparatus, wherein the code executed by the processor causes the image forming apparatus to execute:
acquiring index files from an information processing apparatus, each of the acquired index files including a storage destination of analysis data or a storage destination of print data generated by an information processing apparatus, a category indicating whether data corresponding to the included storage destination is the analysis data or the print data, and link information to a next index file; and
processing the analysis data and the print data corresponding to the storage destinations included in the index files, in an order of the index files connected by the link information, in accordance with the category included in the index file.
